(19) United States
(12) Patent Application Publication
(10) Pub. No.: US 2012/0318212 A1
(43) Pub. Date: Dec. 20, 2012

(54) My Doggie Yo-Yo

(76) Inventor: Lorena Montenegro, Las Vegas, NV (US)

(21) Appl. No.: 13/489,739

(22) Filed: Jun. 6, 2012

Related U.S. Application Data
(60) Provisional application No. 61/498,075, filed on Jun. 17, 2011.

(51) Int. Cl. A01K 27/00

(52) U.S. Cl. 119/792; 119/795; 119/796

(57) ABSTRACT

An architecture is presented that provides a pet leash device designed primarily for pet owners or dog walkers that walk more than one dog. The pet leash device comprises a housing comprising a first and second side portions, a first leash secured to the first side portion, a second leash secured to the second side portion, and a handle secured to the housing. The pet leash device further comprises a rotating pivot component that secures the handle to the housing and allows the housing and the handle to rotate. Additionally, a first connector is secured to an end of the first leash and a second connector is secured to an end of the second leash to secure the first and the second leashes each to a respective dog's collar. Typically, the leashes are retractable within the housing, and a push button controls the extension and retraction of the leashes.

### CROSS-REFERENCE

This application claims priority from Provisional Patent Application Ser. No. 61/498,075 filed Jun. 17, 2011.

### BACKGROUND

For pet owners or dog walkers that walk more than one dog, it can be difficult to hold more than one retractable leash (or other leash) handle at a time. Multiple leashes tend to become tangled with one another, especially if the dogs are active and playful. Additionally, once tangled, it can be hard for the individual to untangle the leashes while also trying to control the dogs. This can lead to the leashes becoming intertwined around the individual, which is not only frustrating but can also be dangerous and painful. A more efficient device is needed.

There is a need for an improved pet leash device that is designed to allow pet owners to walk at least two dogs simultaneously without the need to hold two separate leashes. The present invention discloses a pet leash device that comprises a single handle and two leashes that are designed not to tangle. This device eliminates the frustration of intertwined leashes as the dogs move about and ensures that the pet owner or dog walker is able to control both animals with ease. Pet owners and dog walkers will appreciate the convenience and efficiency that this invention affords.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a pet leash device designed primarily for pet owners or dog walkers that walk more than one animal at a time. The pet leash device comprises a housing comprising a first side portion and a second side portion, a first leash secured to the first side portion of the housing, a second leash secured to the second side portion of the housing, and a handle secured to an end of the housing. The pet leash device further comprises a rotating pivot or swivel component that secures the handle to the end of the housing and allows the housing to rotate relative to the handle, or vice versa. Additionally, a first connector is secured to an end of the first leash and a second connector is secured to an end of the second leash to secure the first and the second leashes each to a respective dog's collar.

Furthermore in the preferred embodiment of the present invention, the first and second leashes of the pet leash device are retractable within the housing. Further, the handle of the pet leash device comprises a push button for controlling the extension and retraction of the first and the second leash. The handle further comprises a recessed area for a user's fingers, and a soft gripping area.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a pet leash device in accordance with the disclosed architecture.

FIG. 2 illustrates a perspective view of the handle and push button of the pet leash device in accordance with the disclosed architecture.

FIG. 3 illustrates a perspective view of a pet leash device with two leashes extending from the housing in accordance with the disclosed architecture.

FIG. 4 illustrates a perspective view of the pet leash device wherein the two leashes do not become tangled in accordance with the disclosed architecture.

FIG. 5 illustrates a perspective view of the pet leash device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a pet leash device that is designed to allow pet owners to walk at least two dogs simultaneously without the need to hold two separate leashes. The pet leash device comprises a single handle and two leashes that are designed to reduce tangling. Specifically, the pet leash device comprises a housing that is further comprised of at least two leashes and, preferably, at least two retractable leashes. The housing may be split up into two halves to resemble a yo-yo. Each retractable leash will be coiled inside its own separate housing. The pet leash device further comprises a handle with a push button for controlling both leashes at the same time. The handle also has a 360 degree rotating pivot or swivel that allows the housing and handle to rotate relative to one another, and reduce the likelihood that the pet leashes will become tangled.

Thus, the pet leash device eliminates the frustration of intertwined leashes as the dogs move about and ensures that the pet owner or dog walker is able to control both animals with ease. The pet leash device, including the housing, handle, and leashes, can be manufactured in a variety of colors and designs. Pet owners and dog walkers will appreciate the convenience and efficiency that this invention affords.

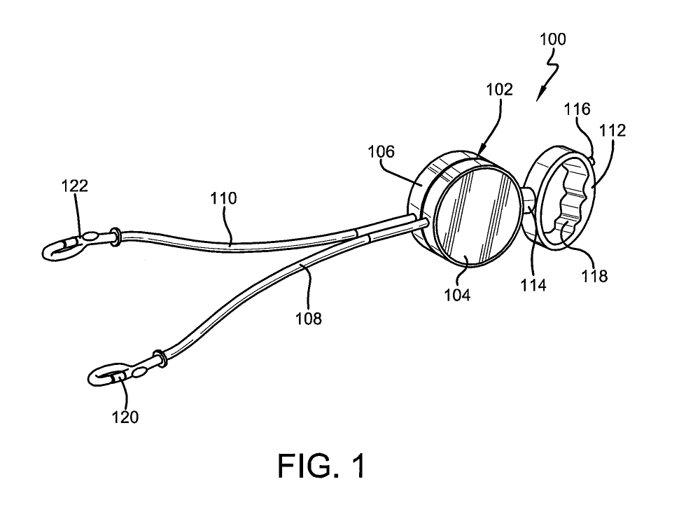

Referring initially to the drawings, FIG. 1 illustrates a pet leash device 100 designed primarily for pet owners or dog walkers that walk more than one animal at the same time. The pet leash device 100 comprises a housing 102 comprising a first side portion 104 and a second side portion 106. Typically, the housing 102 is cylindrical in shape, however any other suitable shape can be used as is known in the art without affecting the overall concept of the invention. The housing 102 would generally be constructed of metal or plastic, such as polycarbonate, acrylonitrile butadiene styrene (ABS) or polyvinyl chloride (PVC), though any other suitable material may be used to manufacture the housing 102 as is known in the art without affecting the overall concept of the invention. The housing 102 is approximately between 1 and 2inches wide as measured from one flat side of the cylinder to the other, and approximately between 3 and 4 inches in diameter. The first side portion 104 and the second side portion 106 are typically secured together to form the housing 102 via gluing, fusing, bonding, etc., or any other suitable securing means as is known in the art. The first side portion 104 and the second side portion 106 can also be manufactured as an integral unit to form the housing 102.

The pet leash device 100 further comprises at least one first leash 108 secured to the first side portion 104 of the housing 102. The at least one first leash 108 has the appearance of a typically constructed leash as is known in the art. Typically, a second leash 110 is secured to the second side portion 106 of the housing 102. The second leash 110 also has the appearance of a typically constructed leash as is known in the art. Additional side portions (not shown) of the housing 102 can be added as is known in the art, with additional leashes (not shown) secured to the additional side portions of the housing depending on the wants and needs of a user and to enable a person to control more than two animals at the same time. The leashes would typically be made of woven nylon, cord, rope, etc. though any other suitable material may be used to manufacture the leashes 108 and 110 as is known in the art without affecting the overall concept of the invention. Generally, the leashes are retractable and can extend from and retract back into the housing 102, but the leashes do not need to be retractable and the pet leash device 100 can function with non-retractable leashes as well. If the leashes are retractable, the retractable leashes are of conventional design and construction as is known in the art, and function the same as retractable leashes known in the art.

The leashes 108 and 110 are coiled inside the housing 102 and secured. Specifically, the first leash 108 is coiled inside the first side portion 104 of the housing 102 and the second leash 110 is coiled inside the second side portion 106 of the housing 102, thus each leash is coiled inside its own separate, side portion of the housing 102. The leashes are secured to the inside of the first and second side portions of the housing 102 via gluing, fusing, bonding, etc., or any other suitable securing means as is known in the art. Additionally, if the leashes are retractable, then the section of the leashes that does not retract may be thicker than the section of the leashes contained within the housing 102.

The leashes further comprise a first connector 120 secured to an end of the first leash 108 and a second connector 122 secured to an end of the second leash 110, which secure the first 108 and the second 110 leashes each to a respective dog or other animal's collar (not shown). The connectors 120 and 122 are well known in the art and typically comprise a metal spring clip, a zip tie, a spring-loaded eyelet, a clevis, or any other suitable connector as is known in the art for connecting a leash to a pet collar.

Furthermore, the pet leash device 100 comprises a handle 112 secured to an end of the housing 102. The pet leash device 100 also comprises a rotating pivot or swivel component 114 that secures the handle 112 to the end of the housing 102 and that allows the housing 102 and the handle 112 to rotate relative to one another. The rotating pivot component 114 can be any pin connection, a ball and socket connection, a swivel connection or any other suitable rotating connection as is known in the art without affecting the overall concept of the invention. Typically, the rotating pivot component 114 allows the housing 102 and the handle 112 to rotate approximately 360 degrees relative to one another. The rotation of the housing 102 and the handle 112 reduces the likelihood that leashes 108 and 110 will become tangled while in use.

The handle 112 further comprises a push button 116 or other suitable single actuation device as is known in the art for controlling the leashes 108 and 110. Specifically, the push button 116 controls the extension and retraction of the leashes 108 and 110. Typically, the push button 116 controls both leashes 108 and 110 at the same time. However, the handle 112 could also comprise additional push buttons (not shown) which would control only one leash independently, and not both leashes. For example, one button could control the extension and retraction of leash 108 and a second button could control the extension and retraction of leash 110.

Additionally, the handle 112 comprises a recessed area 118 for receipt of a user's fingers. The recessed area 118 provides comfort for a user while using the pet leash device 100. A user places their fingers in the recessed area 118 and grasps the handle 112. The handle 112 can also comprise a soft gripping area to provide additional comfort to a user. The soft gripping area can be manufactured of neoprene, urethane, expanded polypropylene (EPP), expanded polyethylene (EPE), or any other suitable material as is known in the art.

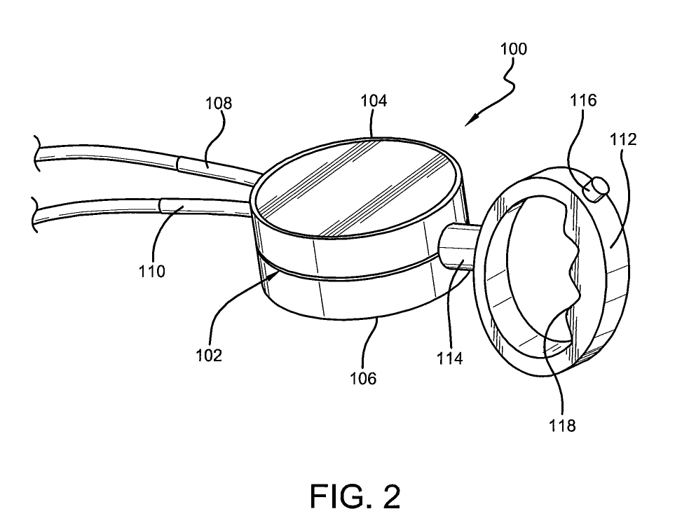

FIG. 2 illustrates the handle 112 and push button 116 of the pet leash device 100. A rotating pivot or swivel component 114 secures the handle 112 to an end of the housing 102. The rotating pivot component 114 allows the housing 102 and the handle 112 to rotate approximately 360 degrees relative to one another. The rotation of the housing 102 and the handle 112 reduces the likelihood that leashes 108 and 110 will become tangled while in use.

The handle 112 further comprises a push button 116 or other suitable single actuation device as is known in the art for controlling the leashes 108 and 110. Specifically, the push button 116 controls the extension and retraction of leash 108 from side portion 104 and leash 110 from side portion 106 of the housing 102. Typically, the push button 116 controls both leashes 108 and 110 at the same time, but additional buttons can be provided to control the leashes independently.

Furthermore, the handle 112 comprises a recessed area 118 for receipt of a user's fingers. The recessed area 118 provides comfort for a user while using the pet leash device 100. The handle 112 can also comprise a soft gripping area to provide additional comfort to a user. The soft gripping area can be manufactured of any suitable material as is known in the art.

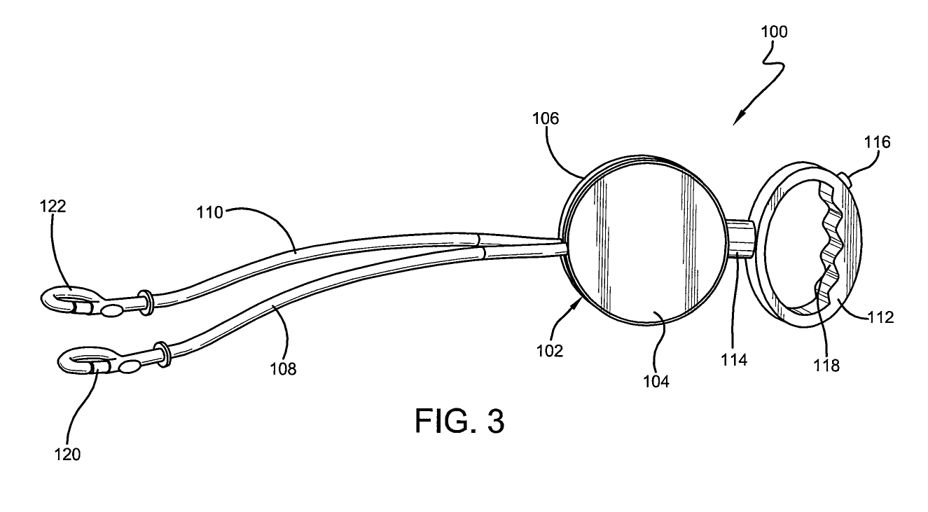

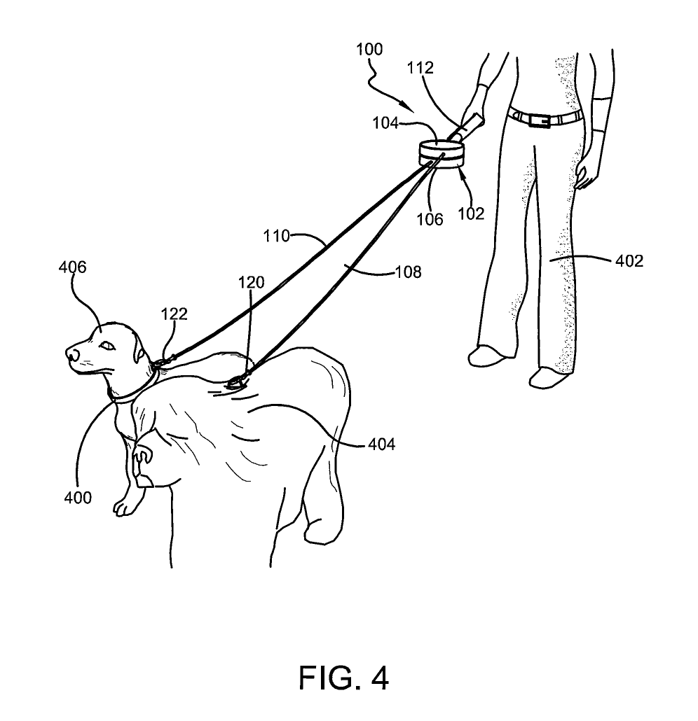

FIGS. 3 and 4 illustrate a pet leash device 100 with two leashes 108 and 110 extending from the housing 102, and wherein the two leashes 108 and 110 do not become tangled together. Specifically, the pet leash device 100 further comprises a first leash 108 secured to the first side portion 104 of the housing 102, and a second leash 110 secured to the second side portion 106 of the housing 102. Generally, the leashes are retractable and can extend from and retract back into the housing 102, but the leashes do not need to be retractable and the pet leash device 100 can function with non-retractable leashes as well. If the leashes are retractable, the retractable leashes may be of conventional design and construction as is known in the art, and function the same as retractable leashes known in the art.

The leashes 108 and 110 are coiled inside the housing 102 and secured. Specifically, the first leash 108 is coiled inside the first side portion 104 of the housing 102 and the second leash 110 is coiled inside the second side portion 106 of the housing 102, thus each leash is coiled inside its own separate, side portion of the housing 102. Additionally, if the leashes are retractable, then the section of the leashes that does not retract may be thicker than the section of the leashes contained within the housing 102.

The leashes further comprise a first connector 120 secured to an end of the first leash 108 and a second connector 122 secured to an end of the second leash 110, which secure the first 108 and the second 110 leashes each to a respective dog's collar 400 of a dog 404 or 406 (see FIG. 4). The connectors 120 and 122 typically comprise a metal spring clip, a zip tie, a spring-loaded eyelet, a clevis, or any other suitable connector as is known in the art for connecting a leash to a pet collar.

Furthermore, the pet leash device 100 comprises a handle 112 secured to an end of the housing 102. The pet leash device 100 also comprises a rotating pivot or swivel component 114 that secures the handle 112 to the end of the housing 102 and that allows the housing 102 and the handle 112 to rotate approximately 360 degrees relative to one another. The rotation of the housing 102 and the handle 112 reduces the likelihood that leashes 108 and 110 will become tangled. Thus, a user 402 can easily walk two dogs 404 and 406 at the same time without intertwining leashes 108 and 110. Additionally, the pet leash device, including the leashes, housing, and handle, can be manufactured in a variety of designs and colors.

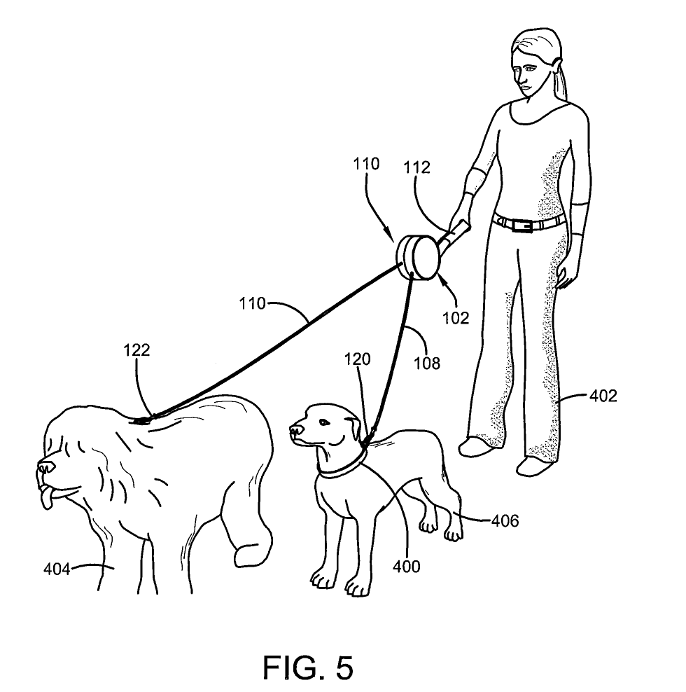

FIG. 5 illustrates the pet leash device 100 in use. In operation, a user 402 would select a pet leash device 100 in a specific design and/or color. A user 402 would then grasp the connectors 120 and 122 of the leashes 108 and 110, and secure the connectors 120 and 122 to the respective dog's collar 400. For example, connector 120 of leash 108 would be secured to dog 406, and connector 122 of leash 110 would be secured to dog 404. A user 402 would then utilize the push button on the handle 112 to extend and retract the leashes 108 and 110 to the desired length, and begin walking the dogs 404 and 406. A rotating pivot or swivel component that secures the handle 112 to the end of the housing 102, allows the housing 102 and the handle 112 to rotate approximately 360 degrees relative to one another. The rotation of the housing 102 and the handle 112 reduces the likelihood that leashes 108 and 110 will become tangled. Thus, a user 402 can easily walk two dogs 404 and 406 at the same time without intertwining leashes 108 and 110 and without the need for two separate leashes.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet leash device comprising:
a housing comprising a first side portion and a second side portion;
a first leash secured to the first side portion of the housing;
a second leash secured to the second side portion of the housing; and
a handle secured to an end of the housing.

2. The pet leash device of claim 1, further comprising a rotating pivot component that secures the handle to the end of the housing and allows the housing and the handle to rotate relative to one another.

3. The pet leash device of claim 1, wherein at least one of the first and the second leashes are retractable within the housing.

4. The pet leash device of claim 3, wherein the handle comprises a push button for controlling extension and retraction of at least one of the first and the second leash.

5. The pet leash device of claim 4, wherein the handle further comprises a recessed area.

6. The pet leash device of claim 5, wherein the handle further comprises a gripping area.

7. The pet leash device of claim 1, further comprising a first connector secured to an end of the first leash and a second connector secured to an end of the second leash to secure the first and the second leashes each to a respective dog's collar.

8. The pet leash device of claim 7, wherein the connector comprises at least one of a spring clip, a zip tie, a spring-loaded eyelet, or a clevis.

9. The pet leash device of claim 1, wherein the first and the second leashes are comprised of woven nylon.

10. The pet leash device of claim 1, wherein the first leash is coiled inside the first side portion of the housing and the second leash is coiled inside the second side portion of the housing.

11. The pet leash device of claim 10, wherein the housing comprises a third side portion and a third leash secured to the third side portion of the housing.

12. A pet leash device, comprising:
a housing comprising a first side portion and a second side portion;
a first leash coiled inside and secured to the first side portion of the housing;
a second leash coiled inside and secured to the second side portion of the housing;
a handle secured to an end of the housing; and
a rotating pivot component that secures the handle to the end of the housing and allows the housing and the handle to rotate relative to one another.

13. The pet leash device of claim 12, wherein the rotating pivot component allows the housing and the handle to rotate approximately 360 degrees.

14. The pet leash device of claim 12, wherein the first and the second leashes are retractable within the housing.

15. The pet leash device of claim 14, wherein the handle comprises a push button for controlling extension and retraction of at least one of said first and second leashes.

16. The pet leash device of claim 12, further comprising a first connector secured to an end of the first leash and a second connector secured to an end of the second leash to secure the first and the second leashes each to a respective dog's collar.

17. The pet leash device of claim 16, wherein the connector comprises at least one of a spring clip, a zip tie, a spring-loaded eyelet, or a clevis.

18. A pet leash device, comprising:
a housing comprising a first side portion and a second side portion;
a first retractable leash coiled inside and secured to the first side portion of the housing;
a second retractable leash coiled inside and secured to the second side portion of the housing;
a handle secured to an end of the housing; and
a rotating pivot component that secures the handle to the end of the housing and allows the housing and the handle to rotate relative to one another; and
wherein the rotating pivot component allows the housing and the handle to rotate approximately 360 degrees.

19. The pet leash device of claim 18, wherein the handle comprises a push button for controlling extension and retraction of at least one of said first and second retractable leashes.

20. The pet leash device of claim 18, further comprising a first metal clip secured to an end of the first retractable leash and a second metal clip secured to an end of the second retractable leash to secure the first and the second retractable leashes each to a respective dog's collar.
